(19) United States
(12) Patent Application Publication
(10) Pub. No.: US 2026/0340481 A1
(43) Pub. Date: Oct. 29, 2026

(54) DETERMINING OPTIMAL HYPERPARAMETER VALUES TO CONFIGURE A MACHINE LEARNING MODEL

(71) Applicant: INTERNATIONAL BUSINESS MACHINES CORPORATION, ARMONK, NY (US)

(72) Inventors: Sumanta Mukherjee, Bangalore (IN); Vijay Ekambaram, Chennai (IN); Arindam Jati, Bengaluru (IN); Pankaj Satyanarayan Dayama, Bangalore (IN); Jayant R. Kalagnanam, Briarcliff Manor, NY (US)

(21) Appl. No.: 19/188,589

(22) Filed: Apr. 24, 2025

(51) Int. Cl. G06N 20/00

(52) U.S. Cl. CPC G06N 20/00

(57) ABSTRACT

Provided are a computer implemented method, system and computer program product for determining optimal hyperparameter values to configure a machine learning model. Model instances comprise the model configured with different sets of hyperparameter values for hyperparameters. The hyperparameter values define a structure of the model instances that control how the model instances operating during training. The model instances are trained with the different sets of hyperparameter values. The model instances run after training with a data set to determine prediction errors for the trained model instances. The model instances are ranked according to the prediction errors for the model instances in a prediction matrix. Hyperparameter values are selected based on the prediction errors in the prediction matrix for the model instances. The selected hyperparameter values are used to configure the model for training.

### BACKGROUND OF THE INVENTION

The present invention relates to a computer implemented method, system and computer program product for determining optimal hyperparameter values to configure a machine learning model.

Hyperparameter Optimization (HPO) for foundation models in time series forecasting involves finding the optimal settings for these models to improve their performance, using techniques such as random search, grid search, or Bayesian optimization.

HPO is the process of finding the best combination of hyperparameter values for a machine learning model. Hyperparameters are settings that are not learned during training, but are set before training begins. Examples of hyperparameters include learning rate, batch size, and the number of layers in a neural network. HPO aims to automate the process of finding these optimal settings, rather than relying on manual trial and error.

Foundation models, like those used for time series forecasting, are large and complex, with many hyperparameters that can impact performance. Manually tuning these hyperparameters can be time-consuming and inefficient. HPO can help find the optimal settings for these models, leading to improved forecasting accuracy and efficiency.

### SUMMARY

Provided are a computer implemented method, system and computer program product for determining optimal hyperparameter values to configure a machine learning model. Model instances comprise the model configured with different sets of hyperparameter values for hyperparameters. The hyperparameter values define a structure of the model instances that control how the model instances operating during training. The model instances are trained with the different sets of hyperparameter values. The model instances run after training with a data set to determine prediction errors for the trained model instances. The model instances are ranked according to the prediction errors for the model instances in a prediction matrix. Hyperparameter values are selected based on the prediction errors in the prediction matrix for the model instances. The selected hyperparameter values are used to configure the model for training.

### BRIEF DESCRIPTION OF THE DRAWINGS

FIG. 1 illustrates an embodiment of a system for optimizing selection of hyperparameter values to configure a machine learning model.

FIG. 2 illustrates an embodiment of an error prediction matrix.

FIG. 3 illustrates an embodiment of a marginal analysis table for a pair of hyperparameters.

FIGS. 4A, 4B, and 4C illustrate an embodiment of operations to determine optimal hyperparameter values for a machine learning model.

FIG. 5 illustrates a computing environment in which the components of FIG. 1 may be implemented.

### DETAILED DESCRIPTION

Described embodiments provide improvements to computer technology for determining hyperparameter values to configure a machine learning model for training. Sets of hyperparameter values for hyperparameters are determined and then used to configure a machine learning model resulting in different model instances. The model instances configured with the different sets of hyperparameter values are trained. The model instances then run to determine prediction errors for the model instances. The model instances are ranked according to the determined prediction errors in a prediction matrix. The hyperparameter values are selected based on the determined prediction error rankings in the prediction matrix. The selected hyperparameter values are then used to configure the model for training and eventual deployment in a production environment.

In described embodiments, a set of possible sets of hyperparameter values may be selected to minimize the prediction errors of the model instance configured with the hyperparameter values, maximize a closeness of fit of channel contributions to the model instance output and goal channel contributions, and to maximize performance of the model instance.

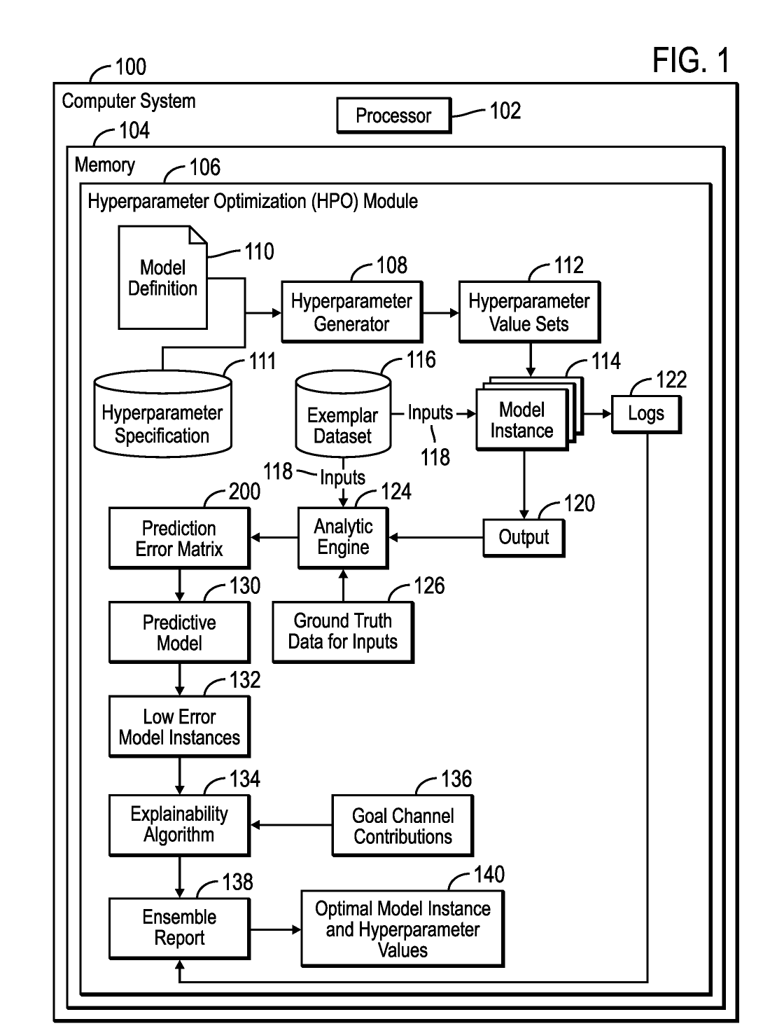

FIG. 1 illustrates an embodiment of a computer system 100 in which embodiments are implemented. The system 100 includes a processor 102 and a main memory 104. The main memory 104 includes a hyperparameter optimization (HPO) module 106 to optimize the selection of hyperparameter values to configure a machine learning model The HPO module 106 includes a hyperparameter generator 108 that receives a model definition 110 of the machine learning model being trained and a hyperparameter specification 111 of possible hyperparameter values for the hyperparameters. The hyperparameter generator generates sets of different combinations of hyperparameter values for hyperparameters defined in the model definition that are in the hyperparameter specification.

A hyperparameter may refer to a parameter that cannot be updated during the training of the machine learning. The hyperparameter values define a structure of the model instances that control how the model instance operates during training. The hyperparameter values can be involved in building the structure of the model, such as the number of hidden layers and the activation function, or in determining the efficiency and accuracy of model training, such as the learning rate (LR) of stochastic gradient descent (SGD), batch size, and optimizer. Other examples of hyperparameters that may be included in the hyperparameter value sets 112 include a number of decoder layers, types of layers, e.g., use of mixer/linear in the decoder, parameter distribution constraints, learning rate control, and enabling forecast channel mixing.

The HPO module 106 generates model instances 114 comprising the machine learning model configured with the different hyperparameter value sets 112. The different model instances 114 comprise the machine learning model configured with different numbers of hidden layers and activation functions, different learning rates, different batch sizes, decoder layers, and channel mixing enabled, etc. The data channels comprise different variates. A variate or variable is a measurable characteristic or attribute, number or quantity used as input for training and making predictions. Variates from different channels may originate from different sources, such as different measurement devices.

The model instances 114 receive inputs 118 for the variates from data sets in an exemplar database 116 of the data. The data sets may comprise annotated data for specific scenarios and have specific attributes, seasonality, etc. This allows the hyperparameter values to be optimized for specific types of data and scenarios. Each model instance 114 receives the same inputs 118 and produces the machine learning outputs 120 or predictions. Each model instance 114 may generate performance information in the logs 122, including computational resources used, processing times, latency, compute time for execution, confidence level/certainty of the outputs, etc.

An analytic engine 124 receives the inputs 118, outputs 120 from the model instances 114, and ground truth data for the inputs 126. Based on these inputs, the model instances generate a prediction error matrix 200 having prediction errors of the outputs 120 from the model instances and the ground truth outputs 126 for each data point in the inputs 118 of the variates. The prediction error matrix 200 ranks the prediction errors for a data point across the different model instances indicating how each model instance performed across data points in a time series of data points. Inputs for all the variates are provided at the data points in the time series.

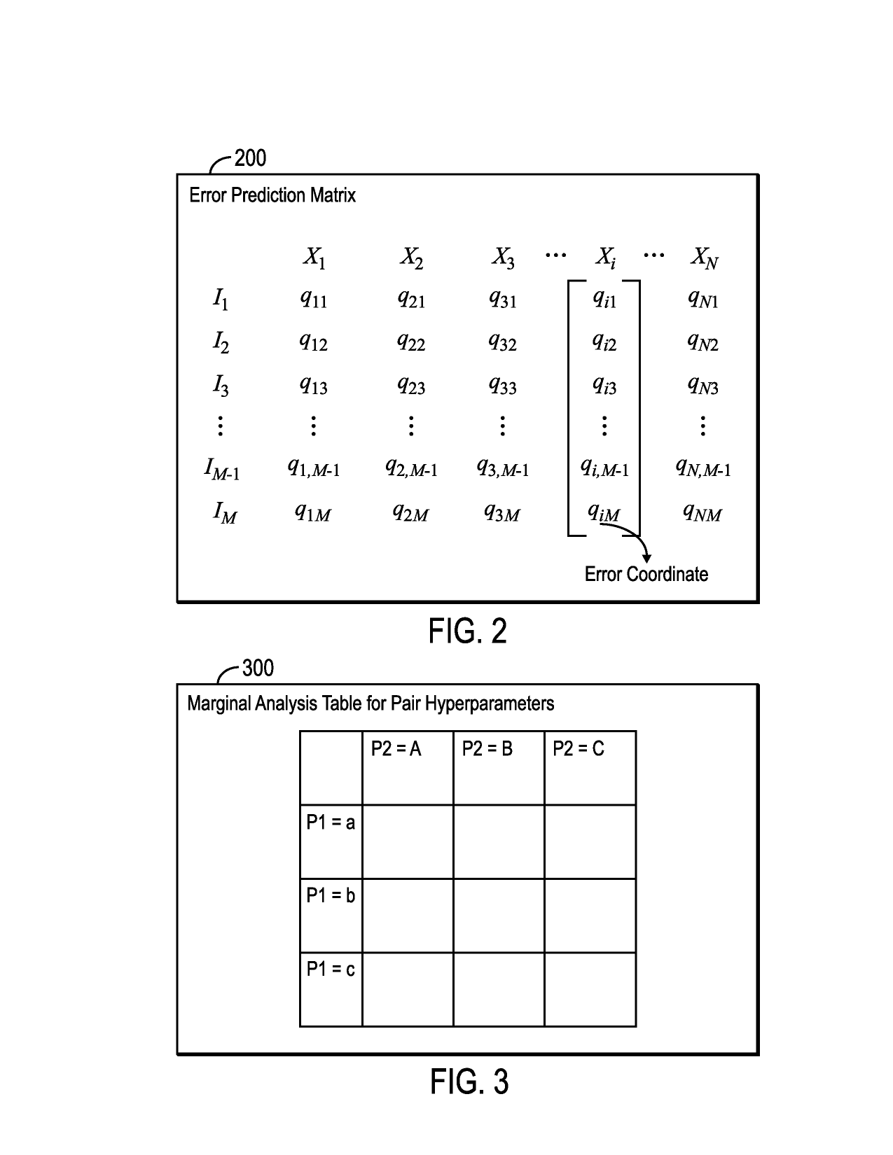

FIG. 2 illustrates an embodiment of the prediction error matrix 200. There are M model instances (Iᵢ), or model instances I₁…I_{M}, represented in the rows of the matrix 200. There is a column for each data point Xⱼ, where j=1…N, or N total data points or time instances. The prediction error ranking q_{i,j} comprises a prediction error for model instance i, and data point j. The prediction error rankings q_{i,j} rank the prediction errors across model instances I₁…_{M} for a data point Xj. In this way, the prediction error matrix indicates how well each model performs with respect to all the model instances for given data points. This identifies model instances with relatively low prediction errors and relatively high prediction errors relative to all the model instances.

The prediction error matrix 200 is inputted to the predictive model 130 to perform an analysis to determine low error model instances 132. The predictive model may perform a marginal analysis to determine how model instances perform using hyperparameter values for different pairs of hyperparameters using the rankings in the prediction error matrix. For instance, the predictive model may determine the rankings for model instances for each hyperparameter value in a pair of hyperparameter values being compared and perform cluster analysis based on the value of the rankings and variance of the rankings for that hyperparameter value for the model instances for each data point. The predictive model may then determine for each pair of hyperparameter values whether the error classification for each data point shifted from a low error rate classification to a high error rate classification and the percentage of data points that experienced such a shift. The predictive model may generate marginal analysis tables showing the percentage of data points for each pair of hyperparameter values that shifted from a low error rate to a high error rate. The predictive model 130 may use the marginal analysis tables to determine those sets of hyperparameter values having low error rates. The model instances having the determined sets of hyperparameter values resulting in low error rates comprise the low error model instances 132, which may be a number of models configured with hyperparameter values resulting in lower error rates than other of the model instances.

FIG. 3 illustrates an example of a marginal analysis table 300 that provides rows for one parameter P1 having different values a, b, c... and columns for a second parameter P2 having different values A, B, C. The cell for each column and row provides the percentage of data points that shifted from a low error rate to a high error rate for a pair of hyperparameter values for two hyperparameters being compared. A marginal analysis table may be generated for each possible pair of hyperparameters. The predictive model may use heuristic rules to determine pairs of hyperparameter values resulting in optimally low percentage of data points that shift from low error to high error to produce selection of hyperparameter values resulting in minimal errors, or minimal shifting from a low error rate to high error rate.

An explainability algorithm 134 may determine cross-channel contributions of the channels/variates for the low error model instances, This analysis determines the correlation of each channel, i.e., variate, to the output results for the low error rate model instances. The explainability algorithm 134 may compare the cross-channel contributions for the model instance with goal channel contributions 136 to determine which low error rate model instances have channel contributions, or cross-channel dependency, most similar to the goal channel contributions. The goal channel contributions 136 may comprise known channel/variate dependencies that are desired for the model. In this way, selection of a final low error model instance may be based on the model having channel contributions, or cross-channel correlation, most similar to the goal channel contributions. This results in models that conform to known channel/variate dependency. The resulting low error model instances also having cross-channel dependencies approximating goal channel contributions are outputted to an ensemble report 138.

In embodiments where there is no knowledge of cross-channel dependency, i.e., no available goal contributions, then the ensemble report 138 may include low error model instances having distinct cross-channel dependencies. The optimal model instance and set of hyperparameter values 140 for that model instance may then be selected from the ensemble report 138.

The ensemble report 138 may also consider the performance logs 122 to filter low error model instances 132 having higher performance attributes of the low error model instances. This allows selection of a set of hyperparameter values filtered by low error rates, having cross-channel dependencies approximating goal channel contributions if available, and having a relatively high performance level. In this way, the set of optimal hyperparameter values may be based on three different dimensions of consideration, minimize prediction errors, maximize cross-channel dependency, and/or maximizes performance. If information on certain of the dimensions is not available, then the set of optimal hyperparameter values may be selected based on fewer of the above described dimensions as well as additional dimensions.

The memory 104 may comprise suitable volatile or non-volatile memory devices known in the art. For instance, the memory 104 may comprise one or more memory devices volatile or non-volatile, such as a Dynamic Random Access Memory (DRAM), a phase change memory (PCM), Magnetoresistive random-access memory (MRAM), Spin Transfer Torque (STT)-MRAM, SRAM storage devices, DRAM, a ferroelectric random-access memory (Efram), nanowire-based non-volatile memory, and Direct In-Line Memory Modules (DIMMs), NAND storage, e.g., flash memory, Solid State Drive (SSD) storage, non-volatile RAM, etc.

Generally, program modules, such as the program components 106, 108, 112, 114, 124, 130, 134, 138, among others, may comprise routines, programs, objects, components, logic, data structures, and so on that perform particular tasks or implement particular abstract data types. The program components and hardware devices of the system 100 may be implemented in one or more computer systems, where if they are implemented in multiple computer systems, then the computer systems may communicate over a network.

The program components 106, 108, 112, 114, 124, 130, 134, 138, among others, may be accessed by the processor 102 from the memory 104 to execute. Alternatively, some or all of the program components 106, 108, 112, 114, 124, 130, 134, 138, may be implemented in separate hardware devices, such as Application Specific Integrated Circuit (ASIC), Field Programmable Gate Arrays (FPGAs) and other hardware devices.

The functions described as performed by the program components 106, 108, 112, 114, 124, 130, 134, 138, among others, may be implemented as program code in fewer program modules than shown or implemented as program code throughout a greater number of program modules than shown.

Certain of the components, such as components 108, 114, 124, 130, 134, 138, may use machine learning algorithms, such as deep learning algorithms and natural language processor (NLP) algorithms. Program components implementing machine learning models may be implemented in an Artificial Intelligence (AI) hardware accelerator, such as an FPGA or a graphics processing unit (GPU).

In certain embodiments, components, such as the model instances 114 implementing a machine learning model, may use machine learning and deep learning algorithms, such as decision tree learning, generative AI, neural network, inductive programming logic, support vector machines, Bayesian network, Recurrent Neural Networks (RNN), Feedforward Neural Networks, Convolutional Neural Networks (CNN), Deep Convolutional Neural Networks (DCNNs), Generative Adversarial Network (GAN), etc.

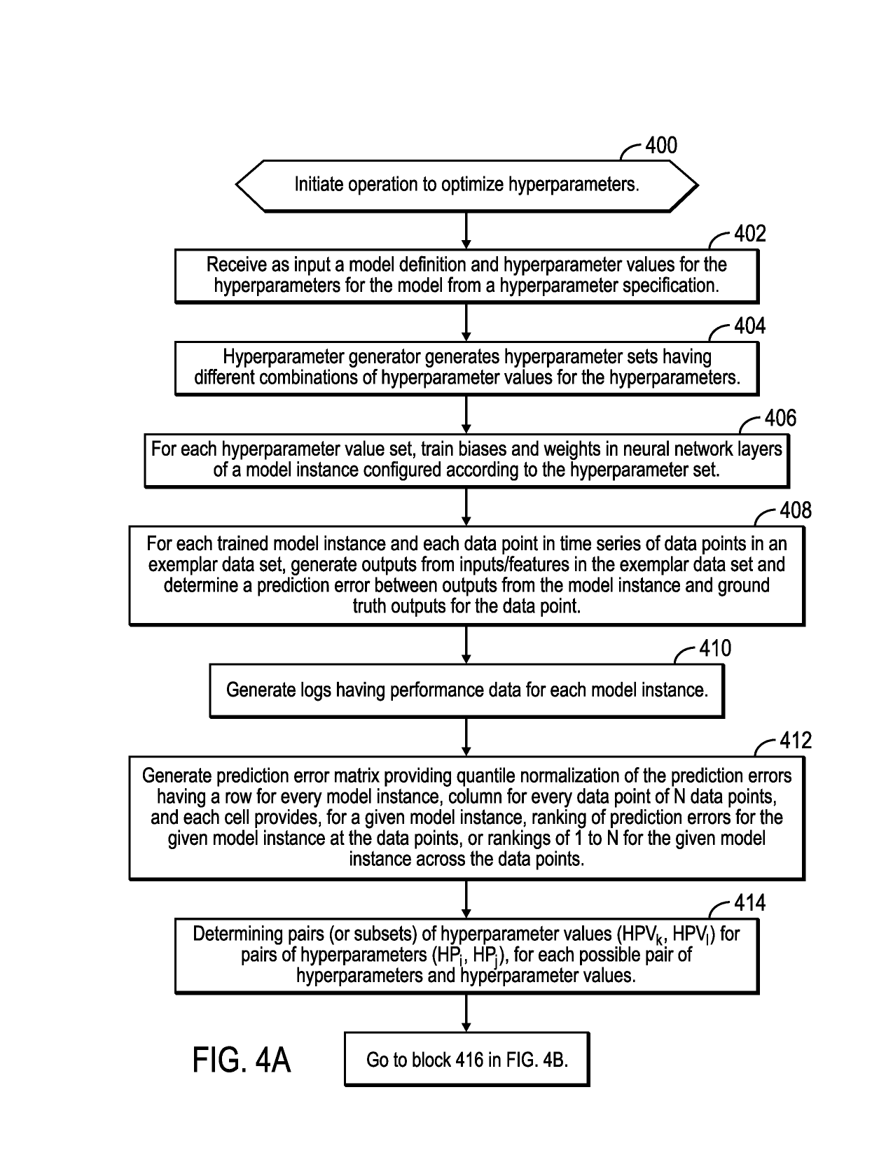

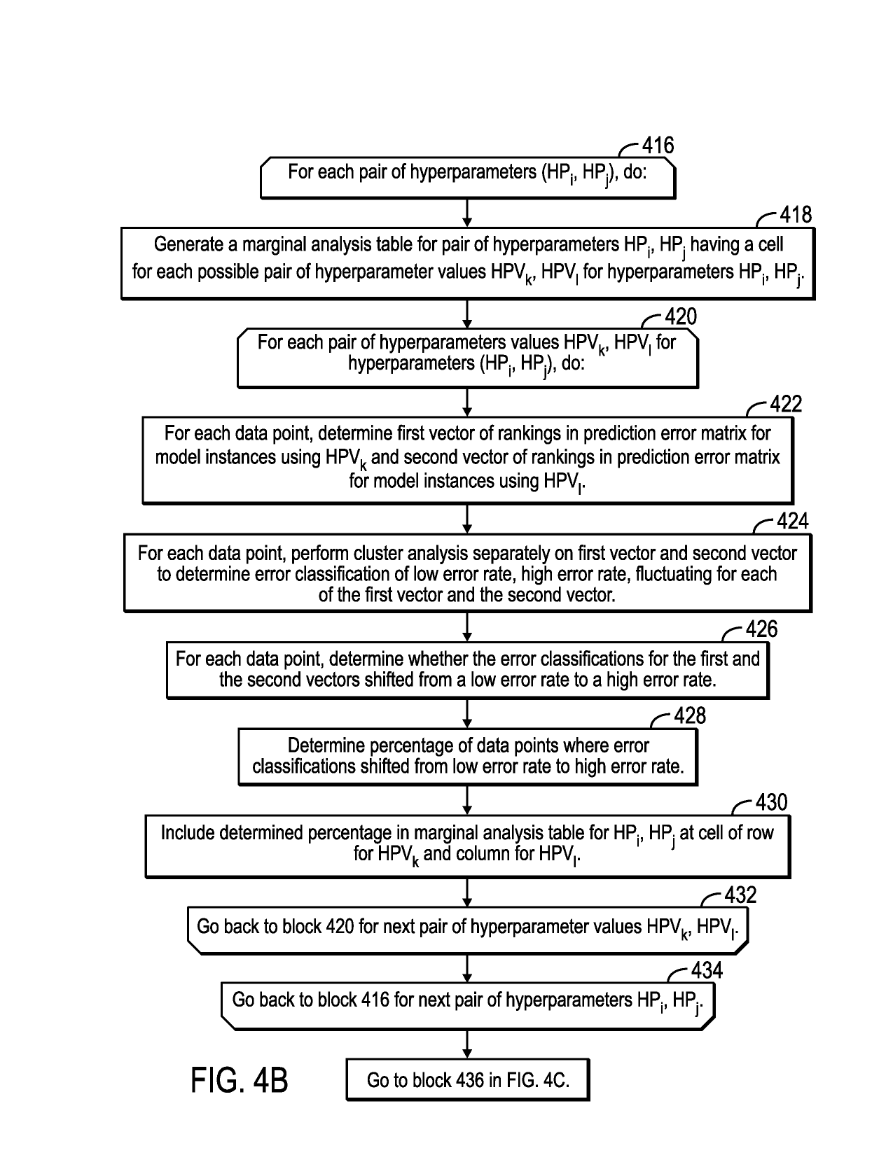

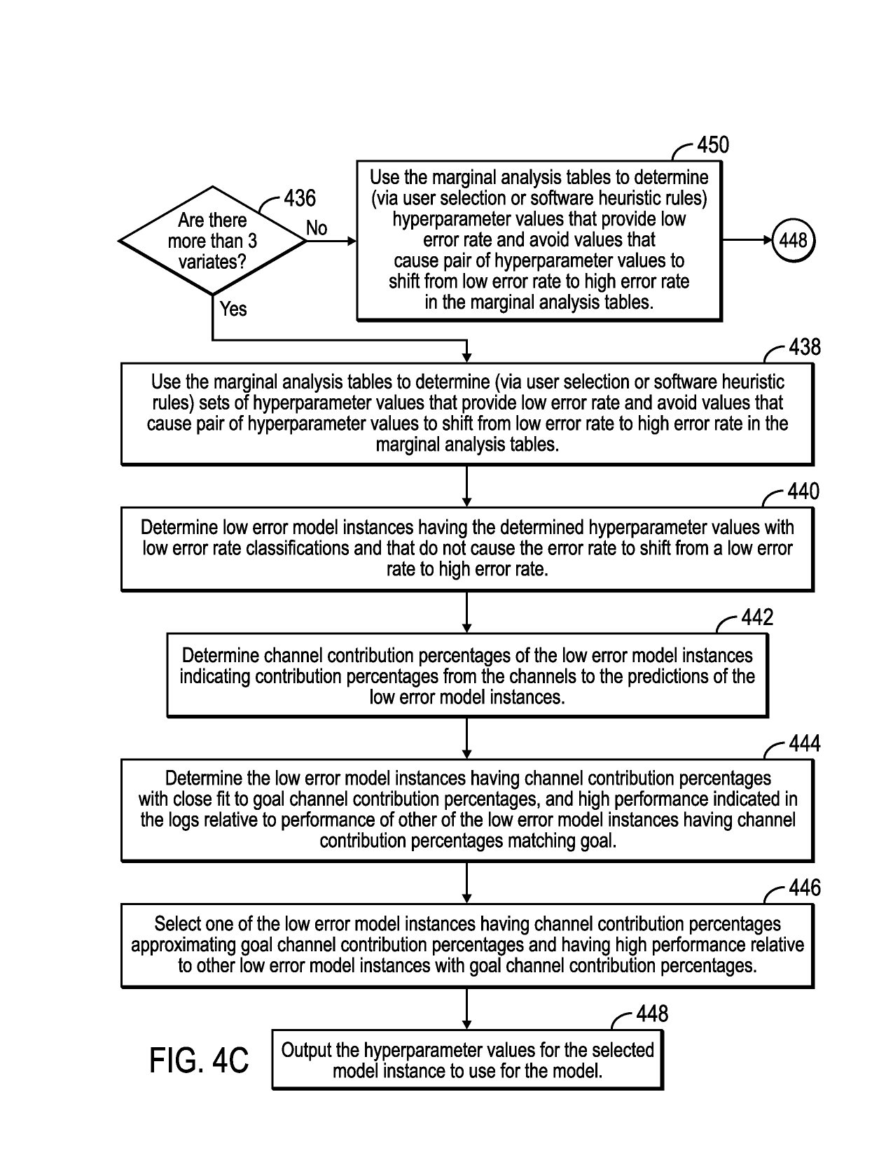

For artificial neural network program implementations, a machine learning model, defined according to the model definition 110, configured with the optimal set of hyperparameter values, determined according to FIGS. 1 and 4A, 4B, 4C, may be trained using backward propagation to adjust weights and biases at nodes in a hidden layer to produce their output based on the received inputs. In backward propagation, biases at nodes in the hidden layer are adjusted accordingly to produce desired output, with specified confidence levels based on the input parameters. Backward propagation may comprise an algorithm for supervised learning of artificial neural networks using gradient descent to minimize the errors in predictions. Given an artificial neural network and an error function, the method may use gradient descent to find the parameters (coefficients) for the nodes in a neural network or function that minimizes a cost function measuring the difference or error between actual and predicted values for different parameters. The parameters are continually adjusted during gradient descent to minimize the error.

In further embodiments, techniques other than backward propagation may be used to train the machine learning model configured with the optimal set of hyperparameter values.

The arrows shown in FIG. 1 between the components in the memory 104 represent a data flow between the components.

FIGS. 4A, 4B, 4C illustrate an embodiment of operations performed by components, such as, but not limited to, components 106, 108, 112, 114, 124, 130, 134, 138 in FIG. 1, to produce an optimal set of hyperparameter values to configure the machine learning model defined according to the model definition 110. Upon initiating (at block 400 in FIG. 4A) an operation to optimize hyperparameter value selection, a hyperparameter optimization (HPO) module, e.g., 106, receives as input (at block 402) a model definition, e.g., 110, and hyperparameter values for hyperparameters for the model definition from a hyperparameter specification, e.g., 111. Hyperparameter value sets, e.g., 112, are generated (at block 404), such as by a hyperparameter generator 108, having different combinations of hyperparameter values for the hyperparameters. For each hyperparameter value set, the biases and weights in neural network layers of a model instance of the model are configured with the hyperparameter value set and trained (at block 406).

For each trained model instance and each data point in time series of data points in the exemplar data set, the outputs are generated (at block 408) from inputs/features in the exemplar data set. For each trained model instance and each data point in time series of data points, the analytic engine, e.g., 124, or other component may determine a prediction error between outputs from the model instance and ground truth outputs for the data point. While running the model instances to produce the outputs, performance data may be stored (at block 410) in logs, e.g., 122, for each of the model instances, such as computational resources, e.g., memory and processor resources consumed while running the model instances, processing time, latency, confidence level/certainty of the output, etc.

The analytic engine may generate (at block 412) a prediction error matrix providing a quantile normalization of the prediction errors. The prediction error matrix may have a row for every model instance and a column for every data point of N data points. Each cell of the prediction error matrix, provides, for a given model instance, a ranking of prediction errors for the given model instance at a data points, or rankings of 1 to N for the given model instance across the N data points. For instance, for model instance i at row i and data point j at column j, cell i, j indicates the ranking of the prediction error for model instance i based on the prediction error for data point j as compared to the prediction errors across the data points j=1…N for model instance i. A lower ranking may indicate a higher or worse prediction error for the data point and model instance.

A predictive model, e.g., 130, determines (at block 414) pairs (or subsets) of hyperparameter values (HPVₖ, HPVₗ) for pairs of hyperparameters (HPᵢ, HPⱼ), for each possible pair of hyperparameters and hyperparameter values. With respect to FIG. 4B, a loop of operations is performed at blocks 416 through block 432 for each pair of hyperparameters HPᵢ, HPⱼ. At block 418, a marginal analysis table is generated for a pair of hyperparameters HPᵢ, HPⱼ having a cell for each possible pair of hyperparameter values HPVₖ, HPVₗ for hyperparameters HPi, HPj. A loop of operations is performed at blocks 420 through 434 for each pair of hyperparameter values HPVₖ, HPVₗ for hyperparameters HPᵢ, HPⱼ. For each data point, the predictive model determines (at block 422) a first vector of rankings in the prediction error matrix for model instances using HPVₖ and a second vector of rankings in prediction error matrix for model instances using HPVₗ. For each data point, a cluster analysis is separately performed (at block 424) on the first vector and the second vector to determine an error classification of low error rate, high error rate, fluctuating based on the rankings in each of the first vector and the second vector. A fluctuating error classification indicates variance in the rankings of high and low error rates such that a determination of a low or high error rate cannot be sufficiently determined.

The predictive model determines (at block 426), for each data point, whether the error classifications for the first and the second vectors shifted from a low error rate to a high error rate. A percentage is determined (at block 428) of data points where error classifications shifted from low error rate to high error rate. The determined percentage is included (at block 430) in the marginal analysis table for HPi, HPj in the cell at the row for HPVₖ and the column for HPVₗ.

The resulting marginal analysis tables for the different pairs of hyperparameters reports detection of parameter shifts across error clusters. The metrics of the percentages of error rates shifting are based on hyperparameter selections in the HPO space. The marginal analysis tables provide a local explainable impact score for every HPO parameter using error coordinate-based clusters and tracking the transition of data instances across clusters based on the hyperparameter state changes. The percentage of shifts in the error classifications for hyperparameter values provides an impact score for all instances of hyperparameter values to enable risk analysis associated with hyperparameter value selection.

Further, each row of a marginal analysis table for a pair of hyperparameter values describes a subset of the hyperparameter values. Changes in the error classifications reflected in different rows/columns in the table, suggests how different model decision boundaries change as hyperparameter values change. Performing this marginal analysis for a representative data set with associated regime tags for a database of specific characteristics, provides a detailed analysis of the choice of hyperparameter values for specific scenarios and operating environments.

After generating the marginal analysis tables for the different pairs of hyperparameters, control proceeds to block 436 in FIG. 4C to determine whether there are more than three variates or channels in the model. If so, then the marginal analysis tables are used (at block 438) to determine (via software heuristic rules) sets of hyperparameter values that result in low errors rate and avoid values that cause pair of hyperparameter values to shift from low error rate to high error rate in the marginal analysis tables. The predictive model then determines (at block 440) low error model instances having the determined hyperparameter values with low error rate classifications and that do not cause the error rate to shift from a low error rate to high error rate. In this way, sets of hyperparameter values are selected that are observed to result in low error rate classifications and do not result in output shifting from a low error rate to a high error rate.

An explainability algorithm determines (at block 442) channel contribution percentages of the low error model instances indicating contribution percentages from the channels to the predictions of the low error model instances. A determination is then made (at block 444) of the low error model instances having channel contribution percentages with a close fit to goal channel contribution percentages and high performance indicated in the logs relative to performance of other of the low error model instances having channel contribution percentages matching goal. The result are model instances configured with sets of hyperparameter values optimized to have low error levels, optimized to have a maximum high cross-channel dependency (i.e., maximize closeness of fit to goal channel contributions), and high performance characteristics reflected in the logs. The resulting model instances may be indicated in an ensemble report 138. One of the low error model instances having channel contribution percentages approximating goal channel contribution percentages and having high performance relative to other low error model instances with goal channel contribution percentages is selected (at block 446) based on optimization selection techniques. The hyperparameter values for the selected model instance are outputted (at block 448) to use for the model.

If (at block 436) the model has three or fewer variates, then the marginal analysis tables are used (at block 450) to determine (via user selection or software heuristic rules) hyperparameter values for the three or fewer variates that provide low error rate and avoid values that cause pair of hyperparameter values to shift from low error rate to high error rate in the marginal analysis tables. Control proceeds to block 448 to output the selected hyperparameter values.

Once the final hyperparameter values are selected, the machine learning model may be configured with the final optimal hyperparameter values and then trained to determine weights and biases for the variates. This trained machine learning model may then deployed in production environments.

With the described embodiments, an optimal set of hyperparameter values is determined for a specific exemplar data set that has specific attributes of data to provide an optimal hyperparameter configuration for data sets having those specific data attributes. This allows different machine learning models for different data attribute characteristics to be configured with different optimal hyperparameter values to optimize performance for data sets having different data attributes.

The present invention may be a system, a method, and/or a computer program product. The computer program product may include a computer-readable storage medium (or media) having computer-readable program instructions thereon for causing a processor to carry out aspects of the present invention.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

In the flowcharts and description, when there is a condition with different operations described as performed depending on the result of the condition, all results of the condition may occur at different times resulting in the different operations performed for the different results of the condition at different times.

A computer program product embodiment ("CPP embodiment" or "CPP") is a term used in the present disclosure to describe any set of one, or more, storage media (also called "mediums") collectively included in a set of one, or more, storage devices that collectively include machine readable code corresponding to instructions and/or data for performing computer operations specified in a given CPP claim. A "storage device" is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits / lands formed in a major surface of a disc) or any suitable combination of the foregoing. A computer-readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

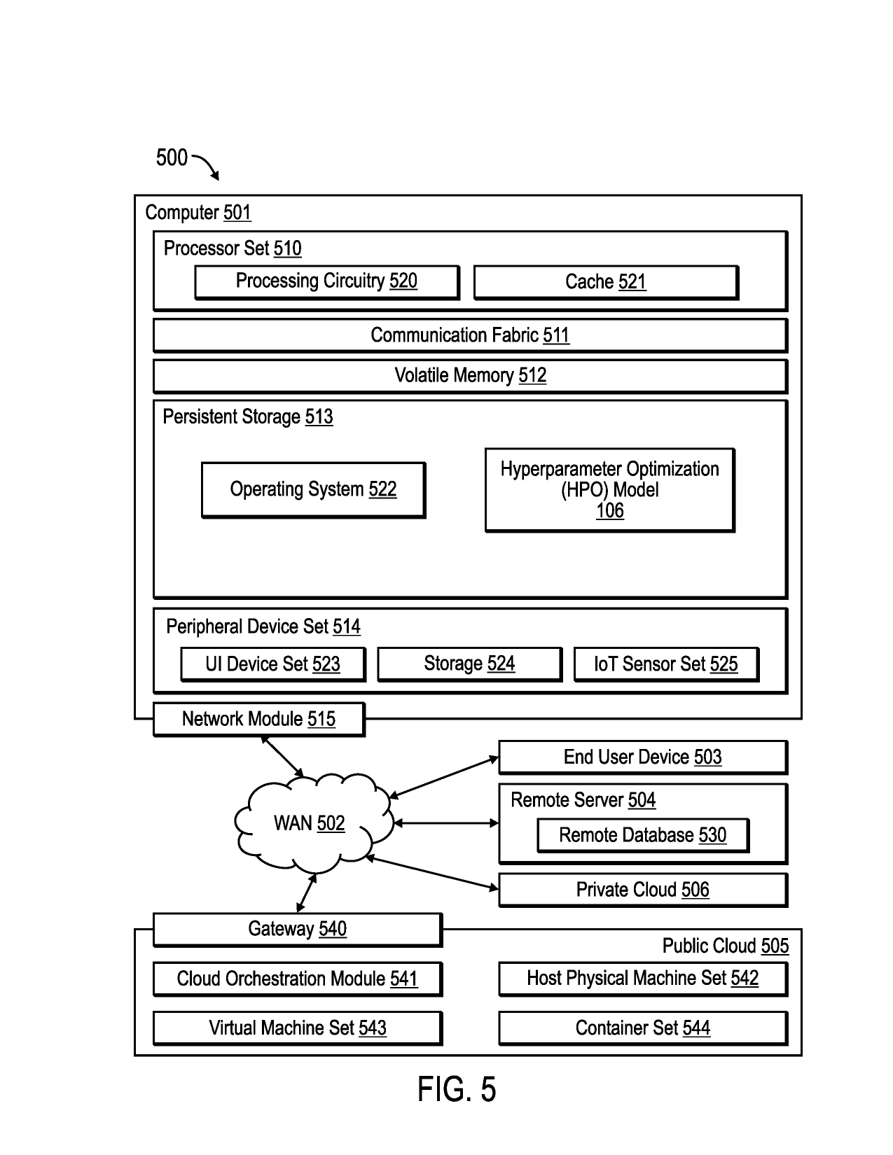

With respect to FIG. 5, computing environment 500 contains an example of an environment for the execution of at least some of the computer code involved in performing the inventive methods, such as determining an optimal set of hyperparameter values, as performed by the HPO module 106 described above. In addition to the HPO module 106, the computing environment 500 includes, for example, computer 501, wide area network (WAN) 502, end user device (EUD) 503, remote server 504, public cloud 505, and private cloud 506. In this embodiment, computer 501 includes processor set 510 (including processing circuitry 520 and cache 521), communication fabric 511, volatile memory 512, persistent storage 513 (including operating system 522 and HPO module 106, as identified above), peripheral device set 514 (including user interface (UI) device set 523, storage 524, and Internet of Things (IoT) sensor set 525), and network module 515. Remote server 504 includes remote database 530. Public cloud 505 includes gateway 540, cloud orchestration module 541, host physical machine set 542, virtual machine set 543, and container set 544.

COMPUTER 501 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 530. As is well understood in the art of computer technology, and depending upon the technology, performance of a computer-implemented method may be distributed among multiple computers and/or between multiple locations. On the other hand, in this presentation of computing environment 500, detailed discussion is focused on a single computer, specifically computer 501, to keep the presentation as simple as possible. Computer 501 may be located in a cloud, even though it is not shown in a cloud in FIG. 5. On the other hand, computer 501 is not required to be in a cloud except to any extent as may be affirmatively indicated.

PROCESSOR SET 510 includes one, or more, computer processors of any type now known or to be developed in the future. Processing circuitry 520 may be distributed over multiple packages, for example, multiple, coordinated integrated circuit chips. Processing circuitry 520 may implement multiple processor threads and/or multiple processor cores. Cache 521 is memory that is located in the processor chip package(s) and is typically used for data or code that should be available for rapid access by the threads or cores running on processor set 510. Cache memories are typically organized into multiple levels depending upon relative proximity to the processing circuitry. Alternatively, some, or all, of the cache for the processor set may be located "off chip." In some computing environments, processor set 510 may be designed for working with qubits and performing quantum computing.

Computer-readable program instructions are typically loaded onto computer 501 to cause a series of operational steps to be performed by processor set 510 of computer 501 and thereby effect a computer-implemented method, such that the instructions thus executed will instantiate the methods specified in flowcharts and/or narrative descriptions of computer-implemented methods included in this document (collectively referred to as "the inventive methods"). These computer-readable program instructions are stored in various types of computer-readable storage media, such as cache 521 and the other storage media discussed below. The program instructions, and associated data, are accessed by processor set 510 to control and direct performance of the inventive methods. In computing environment 500, at least some of the instructions for performing the inventive methods of the HPO module 106 may be stored in persistent storage 513.

COMMUNICATION FABRIC 511 is the signal conduction path that allows the various components of computer 501 to communicate with each other. Typically, this fabric is made of switches and electrically conductive paths, such as the switches and electrically conductive paths that make up buses, bridges, physical input / output ports and the like. Other types of signal communication paths may be used, such as fiber optic communication paths and/or wireless communication paths.

VOLATILE MEMORY 512 is any type of volatile memory now known or to be developed in the future. Examples include dynamic type random access memory (RAM) or static type RAM. Typically, volatile memory 512 is characterized by random access, but this is not required unless affirmatively indicated. In computer 501, the volatile memory 512 is located in a single package and is internal to computer 501, but, alternatively or additionally, the volatile memory may be distributed over multiple packages and/or located externally with respect to computer 501.

PERSISTENT STORAGE 513 is any form of non-volatile storage for computers that is now known or to be developed in the future. The non-volatility of this storage means that the stored data is maintained regardless of whether power is being supplied to computer 501 and/or directly to persistent storage 513. Persistent storage 513 may be a read only memory (ROM), but typically at least a portion of the persistent storage allows writing of data, deletion of data and re-writing of data. Some familiar forms of persistent storage include magnetic disks and solid state storage devices. Operating system 522 may take several forms, such as various known proprietary operating systems or open source Portable Operating System Interface-type operating systems that employ a kernel. The code included in the HPO module 106 typically includes at least some of the computer code involved in performing the inventive methods.

PERIPHERAL DEVICE SET 514 includes the set of peripheral devices of computer 501. Data communication connections between the peripheral devices and the other components of computer 501 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 523 may include components such as a display screen, speaker, microphone, wearable devices (such as goggles and smart watches), keyboard, mouse, printer, touchpad, game controllers, and haptic devices. Storage 524 is external storage, such as an external hard drive, or insertable storage, such as an SD card. Storage 524 may be persistent and/or volatile. In some embodiments, storage 524 may take the form of a quantum computing storage device for storing data in the form of qubits. In embodiments where computer 501 is required to have a large amount of storage (for example, where computer 501 locally stores and manages a large database) then this storage may be provided by peripheral storage devices designed for storing very large amounts of data, such as a storage area network (SAN) that is shared by multiple, geographically distributed computers. IoT sensor set 525 is made up of sensors that can be used in Internet of Things applications. For example, one sensor may be a thermometer and another sensor may be a motion detector. The peripheral device set 514 may further include artificial intelligence processors to perform the training of the model instances.

NETWORK MODULE 515 is the collection of computer software, hardware, and firmware that allows computer 501 to communicate with other computers through WAN 502. Network module 515 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 515 are performed on the same physical hardware device. In other embodiments (for example, embodiments that utilize software-defined networking (SDN)), the control functions and the forwarding functions of network module 515 are performed on physically separate devices, such that the control functions manage several different network hardware devices. Computer-readable program instructions for performing the inventive methods can typically be downloaded to computer 501 from an external computer or external storage device through a network adapter card or network interface included in network module 515.

WAN 502 is any wide area network (for example, the internet) capable of communicating computer data over non-local distances by any technology for communicating computer data, now known or to be developed in the future. In some embodiments, the WAN 502 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 503 is any computer system that is used and controlled by an end user (for example, a customer of an enterprise that operates computer 501), and may take any of the forms discussed above in connection with computer 501. EUD 503 typically receives helpful and useful data from the operations of computer 501. For example, in a hypothetical case where computer 501 is designed to provide a recommendation to an end user, this recommendation would typically be communicated from network module 515 of computer 501 through WAN 502 to EUD 503. In this way, EUD 503 can display, or otherwise present, the recommendation to an end user. In some embodiments, EUD 503 may be a client device, such as thin client, heavy client, mainframe computer, desktop computer and so on. Machine learning models trained with an optimal set of hyperparameter values as determined by the HPO module 106 may be deployed at EUDs 503 to generate machine learning output in production environments.

REMOTE SERVER 504 is any computer system that serves at least some data and/or functionality to computer 501. Remote server 504 may be controlled and used by the same entity that operates computer 501. Remote server 504 represents the machine(s) that collect and store helpful and useful data for use by other computers, such as computer 501. For example, in a hypothetical case where computer 501 is designed and programmed to provide a recommendation based on historical data, then this historical data may be provided to computer 501 from remote database 530 of remote server 504. Machine learning models trained with an optimal set of hyperparameter values as determined by the HPO module 106 may be deployed in an inference engine at the remote server 504 to receive inference requests for machine learning output from at EUDs 503.

PUBLIC CLOUD 505 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 505 is performed by the computer hardware and/or software of cloud orchestration module 541. The computing resources provided by public cloud 505 are typically implemented by virtual computing environments that run on various computers making up the computers of host physical machine set 542, which is the universe of physical computers in and/or available to public cloud 505. The virtual computing environments (VCEs) typically take the form of virtual machines from virtual machine set 543 and/or containers from container set 544. It is understood that these VCEs may be stored as images and may be transferred among and between the various physical machine hosts, either as images or after instantiation of the VCE. Cloud orchestration module 541 manages the transfer and storage of images, deploys new instantiations of VCEs and manages active instantiations of VCE deployments. Gateway 540 is the collection of computer software, hardware, and firmware that allows public cloud 505 to communicate through WAN 502.

Some further explanation of virtualized computing environments (VCEs) will now be provided. VCEs can be stored as "images." A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 506 is similar to public cloud 505, except that the computing resources are only available for use by a single enterprise. While private cloud 506 is depicted as being in communication with WAN 502, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 505 and private cloud 506 are both part of a larger hybrid cloud.

CLOUD COMPUTING SERVICES AND/OR MICROSERVICES (not separately shown in FIG. 5): private and public clouds 506 are programmed and configured to deliver cloud computing services and/or microservices (unless otherwise indicated, the word "microservices" shall be interpreted as inclusive of larger "services" regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to as "as a service" technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

The letter designators, such as i j, k, l, M, N, among others, are used to designate an instance of an element, i.e., a given element, or a variable number of instances of that element when used with the same or different elements.

The terms "an embodiment", "embodiment", "embodiments", "the embodiment", "the embodiments", "one or more embodiments", "some embodiments", and "one embodiment" mean "one or more (but not all) embodiments of the present invention(s)" unless expressly specified otherwise.

The terms "including", "comprising", “having” and variations thereof mean "including but not limited to", unless expressly specified otherwise.

The enumerated listing of items does not imply that any or all of the items are mutually exclusive, unless expressly specified otherwise.

The terms "a", "an" and "the" mean "one or more", unless expressly specified otherwise.

Devices that are in communication with each other need not be in continuous communication with each other, unless expressly specified otherwise. In addition, devices that are in communication with each other may communicate directly or indirectly through one or more intermediaries.

A description of an embodiment with several components in communication with each other does not imply that all such components are required. On the contrary a variety of optional components are described to illustrate the wide variety of possible embodiments of the present invention.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article or a different number of devices/articles may be used instead of the shown number of devices or programs. The functionality and/or the features of a device may be alternatively embodied by one or more other devices which are not explicitly described as having such functionality/features. Thus, other embodiments of the present invention need not include the device itself.

The foregoing description of various embodiments of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto. The above specification, examples and data provide a complete description of the manufacture and use of the composition of the invention. Since many embodiments of the invention can be made without departing from the spirit and scope of the invention, the invention resides in the claims herein after appended.

What is claimed is:

1. A computer implemented method for hyperparameter optimization for a model comprising a machine learning model, comprising:
providing model instances comprising the model configured with different sets of hyperparameter values for hyperparameters, wherein the hyperparameter values define a structure of the model instances that control how the model instances operating during training;
training the model instances with the different sets of hyperparameter values;
running the model instances after training with a data set to determine prediction errors for the trained model instances;
ranking the model instances according to the prediction errors for the model instances in a prediction matrix;
selecting hyperparameter values based on the prediction errors in the prediction matrix for the model instances; and
using the selected hyperparameter values to configure the model for training.

2. The computer implemented method of claim 1, wherein the prediction errors are determined for the model instances for a plurality of data points in the data set in a time series of data points, wherein the prediction matrix includes prediction errors for different model instances for different data points of the data set.

3. The computer implemented method of claim 1, further comprising:
generating logs during running the model instances including performance data on the running of the model instances; and
using the performance data for the model instances in selecting a model instance of the model instances having relatively low prediction errors and relatively high performance level with respect to other of the model instances.

4. The computer implemented method of claim 1, wherein the prediction matrix indicates rankings of the prediction errors of the model instances for a data point of the data set to compare the prediction errors of the model instances for different data points in the data set.

5. The computer implemented method of claim 1, wherein the selecting hyperparameter values based on the prediction errors for the model instances comprises:
selecting subsets of hyperparameter values;
determining prediction error rankings for model instances having the subsets of hyperparameter values;
performing cluster analysis of the prediction error rankings for the model instances to determine error rate classifications for the subsets of hyperparameter values; and
using the error rate classifications for the subsets of hyperparameter values to determine optimal hyperparameter values having a low error rate classification..

6. The computer implemented method of claim 1, wherein the selecting hyperparameter values based on the prediction errors for the model instances comprises:
selecting pairs of hyperparameter values for pairs of hyperparameters;
determining predictions errors of the model instances having the selected pairs of hyperparameter values for the pairs of hyperparameters; and
determining optimal hyperparameter values for the selected pairs that minimize the prediction errors from the model instances having the pairs of hyperparameter values.

7. The computer implemented method of claim 1, wherein the selecting the hyperparameter values comprises:
determining sets of hyperparameter values for the hyperparameters that minimize prediction errors;
determining channel contributions to predictions from model instances configured with the determined sets of hyperparameter values; and
determining one of the model instances having channel contributions with a close fit to a goal channel contributions relative to the channel contributions from other of the model instances, wherein the selected hyperparameter values result in a model instance whose operation minimizes the prediction errors and maximizes closeness of fit of channel contributions to minimize the prediction errors.

8. The computer implemented method of claim 1, wherein the selecting the hyperparameter values further comprises:
determining sets of hyperparameter values for the hyperparameters that minimize prediction errors;
determining performance values of the model instances configured with the determined sets of hyperparameter values; and
selecting one of the determined sets of hyperparameter values having high performance values relative to the performance values of the model instances configured with other of the determined sets of hyperparameter values.

9. The computer implemented method of claim 1, wherein the selecting the hyperparameter values comprises:
determining a set of hyperparameter values for the hyperparameters that minimize prediction errors, that maximize a closeness of fit of channel contributions to goal channel contributions, and that maximizes performance.

10. A computer system for hyperparameter optimization for a model comprising a machine learning model, comprising:
a processor set;
one or more computer-readable storage media; and
program instructions stored on the one or more computer-readable storage media to cause the processor set to perform operations comprising:
providing model instances comprising the model configured with different sets of hyperparameter values for hyperparameters, wherein the hyperparameter values define a structure of the model instances that control how the model instances operating during training;
training the model instances with the different sets of hyperparameter values;
running the model instances after training with a data set to determine prediction errors for the trained model instances;
ranking the model instances according to the prediction errors for the model instances in a prediction matrix;
selecting hyperparameter values based on the prediction errors in the prediction matrix for the model instances; and
using the selected hyperparameter values to configure the model for training.

11. The computer system of claim 10, wherein the prediction errors are determined for the model instances for a plurality of data points in the data set in a time series of data points, wherein the prediction matrix includes prediction errors for different model instances for different data points of the data set.

12. The computer system of claim 10, wherein the selecting hyperparameter values based on the prediction errors for the model instances comprises:
selecting subsets of hyperparameter values;
determining prediction error rankings for model instances having the subsets of hyperparameter values;
performing cluster analysis of the prediction error rankings for the model instances to determine error rate classifications for the subsets of hyperparameter values; and
using the error rate classifications for the subsets of hyperparameter values to determine optimal hyperparameter values having a low error rate classification..

13. The computer system of claim 10, wherein the selecting the hyperparameter values comprises:
determining sets of hyperparameter values for the hyperparameters that minimize prediction errors;
determining channel contributions to predictions from model instances configured with the determined sets of hyperparameter values; and
determining one of the model instances having channel contributions with a close fit to a goal channel contributions relative to the channel contributions from other of the model instances, wherein the selected hyperparameter values result in a model instance whose operation minimizes the prediction errors and maximizes closeness of fit of channel contributions to minimize the prediction errors.

14. The computer system of claim 10, wherein the selecting the hyperparameter values further comprises:
determining sets of hyperparameter values for the hyperparameters that minimize prediction errors;
determining performance values of the model instances configured with the determined sets of hyperparameter values; and
selecting one of the determined sets of hyperparameter values having high performance values relative to the performance values of the model instances configured with other of the determined sets of hyperparameter values.

15. The computer system of claim 10, wherein the selecting the hyperparameter values comprises:
determining a set of hyperparameter values for the hyperparameters that minimize prediction errors, that maximize a closeness of fit of channel contributions to goal channel contributions, and that maximizes performance.

16. A computer program product for hyperparameter optimization for a model comprising a machine learning model, comprising:
one or more computer-readable storage media; and
program instructions stored on the one or more computer-readable storage media to perform operations comprising:
providing model instances comprising the model configured with different sets of hyperparameter values for hyperparameters, wherein the hyperparameter
values define a structure of the model instances that control how the model instances operating during training;
training the model instances with the different sets of hyperparameter values;
running the model instances after training with a data set to determine prediction errors for the trained model instances;
ranking the model instances according to the prediction errors for the model instances in a prediction matrix;
selecting hyperparameter values based on the prediction errors in the prediction matrix for the model instances; and
using the selected hyperparameter values to configure the model for training.

17. The computer program product of claim 16, wherein the prediction errors are determined for the model instances for a plurality of data points in the data set in a time series of data points, wherein the prediction matrix includes prediction errors for different model instances for different data points of the data set.

18. The computer program product of claim 16, wherein the selecting hyperparameter values based on the prediction errors for the model instances comprises:
selecting subsets of hyperparameter values; determining prediction error rankings for model instances having the subsets of
hyperparameter values;
performing cluster analysis of the prediction error rankings for the model instances to determine error rate classifications for the subsets of hyperparameter values; and
using the error rate classifications for the subsets of hyperparameter values to determine optimal hyperparameter values having a low error rate classification..

19. The computer program product of claim 16, wherein the selecting the hyperparameter values comprises:
determining sets of hyperparameter values for the hyperparameters that minimize prediction errors;
determining channel contributions to predictions from model instances configured with the determined sets of hyperparameter values; and
determining one of the model instances having channel contributions with a close fit to a goal channel contributions relative to the channel contributions from other of the model instances, wherein the selected hyperparameter values result in a model instance whose operation minimizes the prediction errors and maximizes closeness of fit of channel contributions to minimize the prediction errors.

20. The computer program product of claim 16, wherein the selecting the hyperparameter values comprises:
determining a set of hyperparameter values for the hyperparameters that minimize prediction errors, that maximize a closeness of fit of channel contributions to goal channel contributions, and that maximizes performance.
